(19) United States
(12) Patent Application Publication
(10) Pub. No.: US 2001/0020407 A1
(43) Pub. Date: Sep. 13, 2001

(54) High-speed shear for transversely cutting rolled strip

(76) Inventors: Horst Grafe, Hilchenbach (DE); Volker Loth, Freudenberg (DE); Jurgen Merz, Kreuztal (DE)

Correspondence Address: Friedrich Kueffner, Suite 1921, 342 Madison Avenue, New York, NY, 10173, US

(21) Appl. No.: 09/755,869

(22) Filed: Jan. 5, 2001

(30) Foreign Application Priority Data
Jan. 19, 2000 (DE) 100 01 928.5

(51) Int. Cl. B26D 1/62

(52) U.S. Cl. 83/13; 83/337; 83/344

(57) ABSTRACT

A high-speed shear for transversely cutting rolled strip with knife carriers which can be driven for rotation and are arranged in pairs opposite each other. The knife carriers are arranged with a fixed distance between each other on both sides of the strip in a common shear cassette. The shear cassette is mounted within an outer frame and the shear cassette is provided with a lifting device for raising or lowering the shear cassette within the outer frame. In a method for operating the shear, the two knife carriers are moved into a horizontal position for allowing the strip end to enter or travel through, and the shear cassette is moved within the outer frame into a raised transfer position.

### BACKGROUND OF THE INVENTION

1. Field of the Invention

The present invention relates to a high-speed shear for transversely cutting rolled strip with knife carriers which are drivable for rotation and are arranged in pairs opposite each other.

2. Description of the Related Art

High-speed shears of the above-described type are generally known in the art.

For example, DE 196 37 862 A1 describes a flying shear with knife edges arranged on oppositely located drums, wherein the knife edges can be accelerated to the feeding speed of the strip to be cut and can be moved towards each other for carrying out a cut. The invention on which this shear is based resides in that the drums arranged on opposite sides can be accelerated by a driving device provided for at least one of the drums to a circumferential speed corresponding to the speed of the strip to be cut, and that at least one of the drums is provided with a separately controllable adjusting device.

DE 197 46 528 A1 describes a high-speed shear which includes two drums, wherein one of the drums is equipped or constructed as a chisel knife and the other is equipped or constructed as an anvil interacting with the other drum. The two drums are moved towards each other for cutting a continuously rolled strip by means of a controlled adjusting device. The synchronization of the two drums is effected by means of electric, electronic or gear-technological means.

EP 0 904 877 A2 discloses a high-speed shear with knife drums which have slightly different diameters and are driven with a slight speed difference through an external branched gear unit. Using an adjusting device through spreading levers, the drums are moved into the cutting position with oppositely located positions of the knives and, after the cut of the rolled strip has been carried out, the drums are moved once again apart from each other.

Finally, DE-OS 26 54 866 describes a flying shear with coupled knife drums. The shear includes a drum turning device with a force transmission coupling both drums for speeds synchronous with the running speed of the supplied material, and a drum adjusting device for adjusting a cutting drum between an open position and a cutting position, and a control device for the motor of the adjusting device, wherein the control device controls the start of the first cutting drum and the adjustment into the cutting position and the return movement of the drum into the initial position. The means for coupling the drums, the drum adjusting device as well as the control device required for the drum adjusting device are of extremely complicated construction which is susceptible to problems. When force transmission takes place, four gear wheels are in engagement with each other, so that a play of the sides of the gear teeth caused by the engagement may lead to an angular deviation of the interacting drum knife and, thus, to damage or to unclean cuts.

### SUMMARY OF THE INVENTION

Therefore, starting from the prior art discussed above, it is the primary object of the present invention to further develop a high-speed shear for cutting hot-rolled and/or cold-rolled strip in such a way that exact cuts can be securely carried out at strip speeds of up to about 20 m/sec even if the strip thickness is as little as, for example, 0.8 mm, and that the structural, mechanical and especially gear-technological and control-technological requirements for achieving these cuts are minimized.

In accordance with the present invention, in a high-speed shear of the above-described type, the knife carriers on both sides are mounted in a common shear cassette with a fixed distance between the knife carriers. The shear cassette is mounted within an outer frame and the shear cassette is provided with lifting means for raising or lowering the shear cassette within the outer frame.

In accordance with the solution provided by th e present invention, both drums are mounted in a single closed rigid structural component, which means that the distances traveled by the component under force are short and the synchronization gear wheels always remain in engagement. A large funnel-shaped opening is ensured for the strip beginning, even if the strip beginning has an upwardly bent front edge. The danger of damage to the shear resulting from upwardly bent strips is reduced.

In accordance with a method for operating the shear, the two knife carriers are moved into the horizontal position and the shear cassette is moved into a raised transfer position within the outer frame when a strip end enters or travels through.

In accordance with a further development of the method, the start-up of the shear is carried out with rotary acceleration of the rate of rotation, wherein the knife carriers are adjusted so as to be at a distance from each other through eccentric bushings and the shear cassette is raised or lowered with its bearing chocks.

It is advantageous that the acceleration time for the startup of the shear is determined by the step-up ratio between the eccentric bushings and the knife carriers.

In accordance with a further development of the concept of the present invention, the gear geometry of the synchronization gear wheels of the knife carriers is selected in such a way that a displacement in a direction parallel to the axis of the knife carriers of, for example, plus/minus 15 mm is permitted.

In accordance with an advantageous feature, a synchronous rotation of both knife carriers of less than 0.5 mm can be maintained for an exact arch-shaped cut with a small strip thickness of, for example, 0.8 mm.

In accordance with a further development of the present invention, exactly mounted arch-shaped knives are used for the flying shear at a strip speed of 20 m/sec for carrying out an arch-shaped cut with two knives.

Finally, in accordance with another further development of the method of the invention, the tension of the strip for cutting the strip is effected between two pairs of drivers.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1a is a schematic side view of the shear according to the present invention with raised shear cassette as a rolled strip beginning enters or travels through, with both knife carriers being in the horizontal position;

FIGS. 1b through 1d show individual phases of adjustment of the knife carriers as their rotation is accelerated from zero to the rate of rotation for cutting the strip;

FIG. 2 is a kinematic schematic view of the drive of the knife carriers with their shafts supported in eccentric bushings;

FIGS. 3a through 3c are schematic illustrations of the sequences of movement of the knife carriers and eccentric bushings, starting from the transfer position according to FIG. 3a to the cutting position in FIG. 3c;

FIG. 4a is a side view of the shear shown in the transfer position; and

FIG. 4b is a side view of the shear in a cutting position.

### DESCRIPTION OF THE PREFERRED EMBODIMENTS

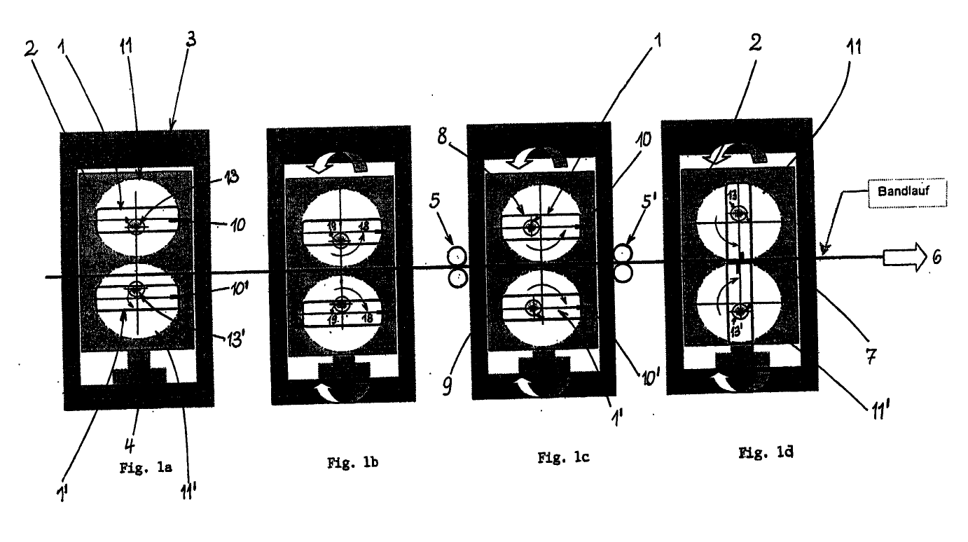

FIGS. 1 to 4 of the drawing show the high-speed shear according to the present invention for transversely cutting rolled strip with knife carriers 1, 1′ which are located opposite each other in pairs and which can be driven for rotation.

The knife carriers 1, 1′ are mounted on both sides in a common shear cassette 2 with a fixed distance between the knife carriers, wherein the shear cassette 2 is arranged within an outer frame 3, and wherein the shear cassette 2 has lifting means 4 for raising and lowering the shear cassette 2 within the outer frame 3.

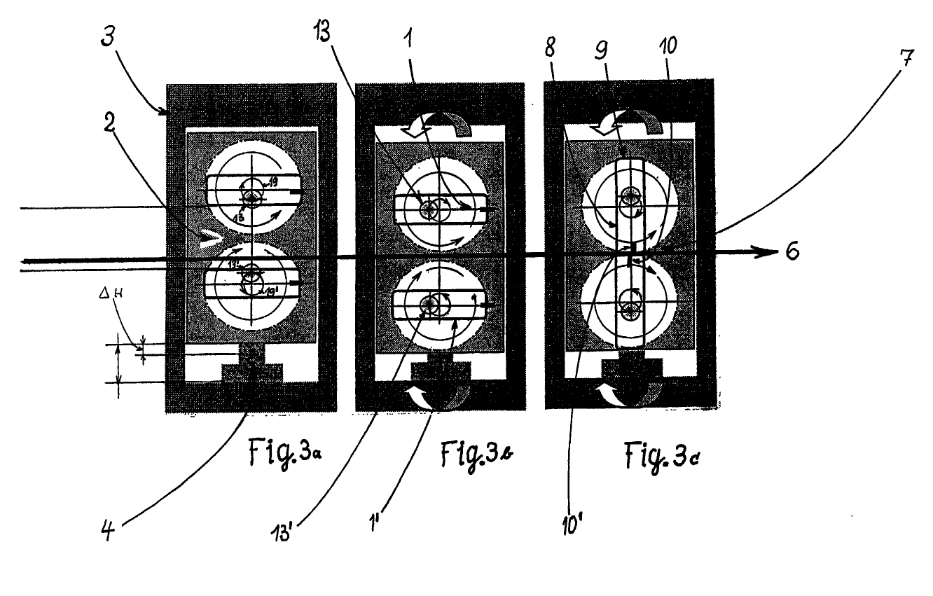

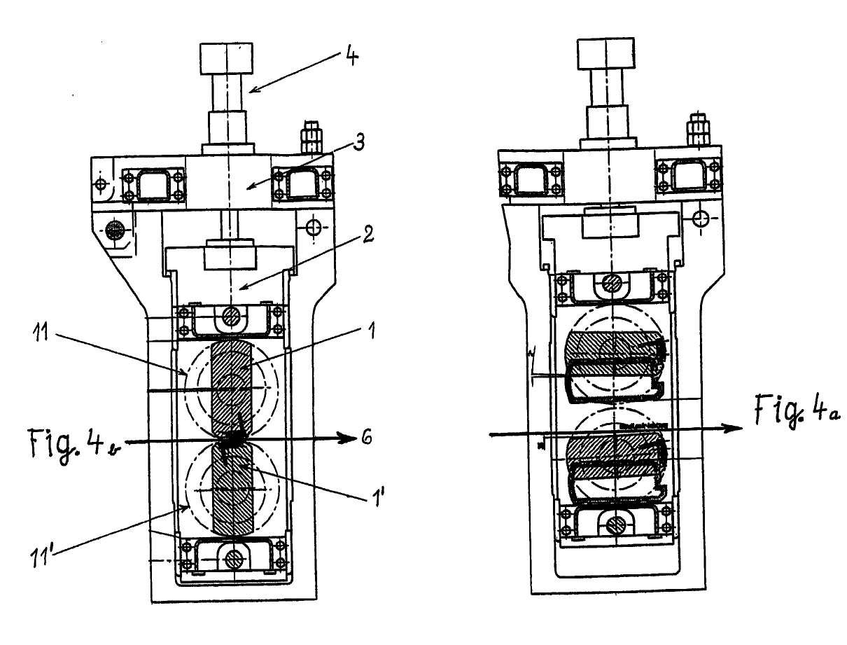

These lifting means 4 can be arranged either below the shear cassette 2, as illustrated in FIGS. 1 and 3, wherein the lifting means produce a pressure for overcoming the weight of the shear cassette 2, or the lifting means 4 may be arranged above the outer frame 3, as illustrated in FIGS. 4a, 4b, in which case the lifting means raise the cassette 2 by pulling; in both cases the lifting means 4 act in the same direction.

In accordance with an embodiment of the invention, the shear can be provided with means 5, 5′ for guiding the strip 6 relative to the cutting position 7, as illustrated in FIG. 1c. These means 5, 5′ may be a pair of drivers each, as is known in the art, wherein the drivers maintain the strip 6 under tension at least in the cutting position 7.

As can be clearly seen, for example, in FIG. 1c, each knife carrier 1, 1′ is constructed as a rectangular body with a pair of long sides 8 and a pair of short sides 9, wherein always two short sides 9 are provided with knife arrangements 10, 10′ which can interact in the cutting position 7.

As can be seen in FIG. 1d, the knife carriers 1, 1′ are synchronized within the shear cassette 2 for rotation in opposite directions by means of gear wheels 11, 11′ provided for the knife carriers, wherein the gear wheels are always in engagement with each other.

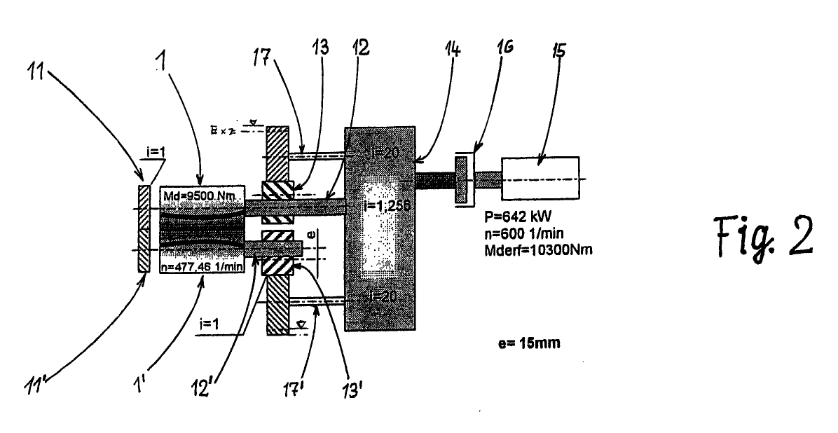

An important embodiment of the invention results from the fact that the knife carrier shafts 12, 12′ are mounted in eccentric bushings 13, 13′, as particularly illustrated in FIG. 2, wherein the knife carrier shafts 12, 12′ and the eccentric bushings 13, 13′ are driven through a common gear unit 14 with a fixed transmission ratio between the eccentric bushings 13, 13′and the knife carrier shafts 12, 12′. As can be seen in this connection particularly in FIG. 1b, the direction of rotation 18 of the knife carriers 1, 1′ is opposite to the direction of rotation 19 of the eccentric bushings.

Consequently, in accordance with the fixed transmission ratio, a cutting position 7 is reached always after a number of rotations of the knife carriers 1, 1′, wherein, as shown in FIG. 1d, the cutting position 7 is reached when the eccentric bushings 13, 13′ are in the upper zenith point 13 and in the lower zenith point 13′, respectively, wherein the knife arrangements 10, 10′ are then in engagement with each other for cutting the strip.

As seen in FIGS. 1a and 3a, the knife carriers 1, 1′ are each raised with the shear cassette 2 in the transfer position, wherein the eccentric bushing 13 is then on its circular travel path 19 in the lower zenith point thereof, and the eccentric bushing 13a in its circular travel path 19′ is in the upper zenith point thereof, and wherein the knife carriers 1, 1′ then assume the greatest possible distance between each other.

FIG. 4a is a side view of the shear in the position in which the strip 6 travels through, and FIG. 4b shows the shear in the cutting position.

As can be seen in FIG. 4a and FIGS. 1a and 3a, the two knife carriers 1, 1′ are moved in the horizontal position for allowing a rolled strip beginning to enter the travel through and the raised shear cassette 2 within the outer frame 3 is moved into a transfer position which makes it possible for the strip beginning to travel through the shear without problem even if the front end of the strip is bent upwardly.

Subsequently, for starting up the shear, the rate of rotation of the shear is accelerated with the knife carriers 1, 1′ being spaced apart from each other and the shear cassette 2 with its bearing chocks is lowered. The time required for accelerating the start-up of the shear is determined by the transmission ratio between the eccentric bushings 13, 13′ and the knife carriers 1, 1′.

It is essential that the gear geometry of the synchronization gear wheels of the knife carriers 1, 1′ is selected in such a way that a displacement in a direction parallel to the axis of the knife carriers of, for example, plus/minus 15 mm is possible. It is important for a problem-free operation of the shear that, for an exact arch-shaped cut with a small strip thickness of, for example, 0.8 mm, a synchronous rotation of both knife carriers 1, 1′ of less than 0.5 mm is maintained. This prevents damage to the knife arrangement 10, 10′.

In the flying shear for a strip travel speed of up to 20 m/sec it is of essential importance for carrying out a clean arch-shaped cut with two knives that precisely mounted arch-shaped knives are used, as shown, for example, in FIG. 2.

In addition, it is also required for a correct cut that the strip 6 is tensioned between two pairs of drivers 5, 5′, as shown in FIG. 1c.

The invention is not limited by the embodiments described above which are presented as examples only but can be modified in various ways within the scope of protection defined by the appended patent claims.

We claim:

1. A high-speed shear for transversely cutting rolled strip, the shear comprising rotatably drivable knife carriers arranged in pairs opposite each other, wherein the knife carriers are mounted at a fixed distance between each other in a common shear cassette, wherein the shear cassette is mounted within an outer frame, and wherein the shear cassette comprises lifting means for raising or lowering the shear cassette within the outer frame.

2. The shear according to claim 1, further comprising means for guiding the strip relative to a cutting position.

3. The shear according to claim 2, wherein each knife carrier is a flat body with two long sides and two short sides, and wherein each short side has a knife arrangement, and wherein the knife arrangements are configured to interact in the cutting position.

4. The shear according to claim 1, wherein the knife carriers are mounted within the shear cassette so as to be synchronized for opposite rotation through gear wheels of the knife carriers which are in permanent engagement with each other.

5. The shear according to claim 1, comprising knife carrier shafts mounted in eccentric bushings, wherein the knife carrier shafts are configured to be driven through a common gear unit with a fixed predetermined transmission ratio between the eccentric bushings and the knife carrier shafts.

6. A method of operating a high-speed shear for transversely cutting rolled strip with rotatably drivable knife carriers arranged oppositely in pairs, wherein the knife carriers are mounted with a fixed distance between each other in a common shear cassette, wherein the shear cassette is mounted within an outer frame, and wherein the shear cassette includes lifting means for raising or lowering the shear cassette within the outer frame, the method comprising, for permitting a rolled strip end to enter and travel through, moving the two knife carriers in a horizontal position and moving the shear cassette in a raised position within the outer frame.

7. The method according to claim 6, comprising carrying out a start-up of the shear by accelerating the rate of rotation of the shear, adjusting the distance of the knife carriers through eccentric bushings, and lowering the shear cassette with bearing chocks of the shear cassette.

8. The method according to claim 7, wherein a time for the start-up of the shear is determined by a transmission ratio between the eccentric bushings and the knife carriers.

9. The method according to claim 6, wherein the knife carriers are synchronized for opposite rotation within the shear cassette through gear wheels of the knife carriers which are in constant engagement with each other, further comprising configuring a tooth geometry of the gear wheels of the knife carriers, such that an axial displacement of the knife carriers of plus/minus 15 mm is possible.

10. The method according to claim 6, wherein the knife carriers have arch-shaped cutting knives, comprising maintaining a synchronization of both knife carriers of less than 0.5 mm for obtaining an exact arch-shaped cut of a strip having a thickness of 0.8 mm.

11. The method according to claim 6, comprising exactly mounting the arch-shaped knives for carrying out an arch-shaped cut with two knives at a travel speed of the strip of up to 20 m/sec.

12. The method according to claim 6, comprising maintaining a tension of the strip between two pairs of drivers.

13. The method according to claim 8, comprising rotating the eccentric bushings opposite to the rotation of the knife carriers.
